(19) United States
(12) Patent Application Publication
(10) Pub. No.: US 2023/0072592 A1
(43) Pub. Date: Mar. 9, 2023

(54) BURNER AND MOBILE HEATING DEVICE

(71) Applicant: Webasto SE, Stockdorf (DE)

(72) Inventors: KLAUS MÖSL, Stockdorf (DE); MARKUS BECKERS, Stockdorf (DE); CHRISTIAN SCHWEYER, Stockdorf (DE); ANDREAS RUTSCHE, Stockdorf (DE); THORSTEN PANNWITZ, Stockdorf (DE); CHRISTOPH HAMPEL, Stockdorf (DE)

(21) Appl. No.: 17/791,682

(22) PCT Filed: Dec. 8, 2020
(86) PCT No.: PCT/EP2020/085075

§ 371 Date: Jul. 8, 2022

(30) Foreign Application Priority Data
Jan. 10, 2020 (DE) 10 2020 100 402.8

(51) Int. Cl. F23D 3/40; B60H 1/22

(52) U.S. Cl. CPC F23D 3/40; B60H 1/2203; F23D 2900/05002; F23D 2900/21002; B60H 2001/2271

(57) ABSTRACT

A burner for a mobile fuel-operated heating device, in particular for a vehicle heating device, comprising: —an evaporator receiving body for receiving an evaporator assembly for distributing and evaporating liquid fuel and—at least one fuel supply line for supplying liquid fuel to the evaporator assembly, wherein the burner has a circumferential wall with a plurality of air supply openings, and the circumferential wall has an increased thickness at least in a first region which surrounds one of the air supply openings in comparison to the thickness in a second region which lies between two air supply openings. The invention additionally relates to a mobile heating device and to a method for producing the evaporator receiving assembly.

### CROSS-REFERENCE TO RELATED APPLICATIONS

This application represents the national stage entry of PCT International Patent Application No. PCT/EP2020/085075 filed on Dec. 8, 2020 and claims priority to German Patent Application No. 10 2020 100 402.8 filed Jan. 10, 2020. The contents of each of these applications are hereby incorporated by reference as if set forth in their entirety herein.

### DESCRIPTION

The disclosure relates to a burner for a mobile, fuel-operated heating device, in particular for a vehicle heating device, and to a mobile, fuel-operated heating device, in particular a vehicle heating device and to a method for producing a burner.

Burners, in particular evaporator burners, are used in particular in independent vehicle heaters and/or auxiliary heaters, especially for vehicles, that are operated with liquid fuel.

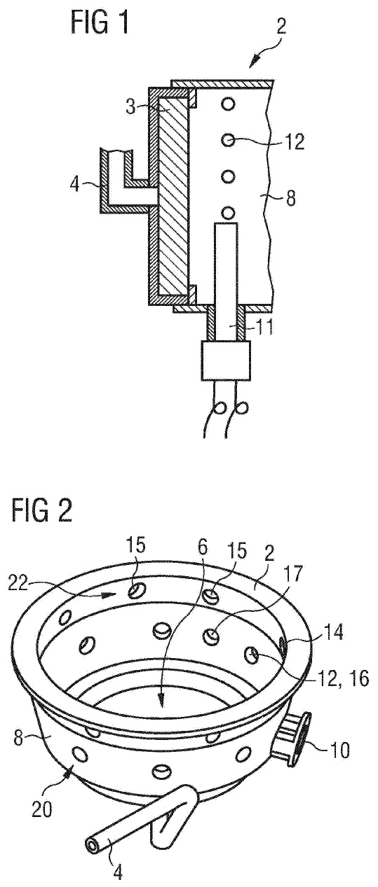

Such a burner may include an evaporator receiving arrangement. FIG. 1 shows an evaporator receiving arrangement 2 according to the prior art. In such evaporator burners, liquid fuel is fed into an evaporator 3 via a fuel supply line. Metal fiber fleeces, for example, can be used as the evaporator itself. The evaporator soaks up liquid fuel, in particular by capillary action, and distributes liquid fuel. By means of the heat provided by a glow plug 11 or ignition element, liquid fuel is vaporized and ignited so that combustion of the fuel can take place when air is supplied. Air supply openings 12 are arranged in a circumferential wall 8 for this purpose. Such an arrangement is known, for example, from DE 10 2018 111 636 A1.

According to the prior art, an evaporator burner is known from DE 10 2005 032 980 B4, which comprises a combustion chamber housing in which an evaporator medium is accommodated in a bowl-like carrier. A fuel supply line is accommodated in the bottom region of the combustion chamber housing. The combustion chamber housing has a circumferential wall which is provided with exactly one row of air supply openings arranged in the circumferential direction. The air supply openings each have a radial extension direction, i.e. parallel to a circumferential wall normal. Such a perforation of the combustion chamber has the disadvantage that fuel and air are distributed inhomogeneously in the combustion chamber and thus combustion proceeds in an undefined manner in the sense of an ideal combustion process characterized by a complete and low-emission combustion. Soot formation and greatly increased NOx emissions can occur in this process. Usually, the distribution of air and fuel and thus the combustion can be improved by an empirical design of the ventilation.

Another combustion chamber assembly is known from DE 10 2012 211 932 B3. This combustion chamber assembly has a plurality of combustion air inlet openings, of which at least one of the combustion air inlet openings has a opening longitudinal axis which is inclined with respect to a surface normal of the circumferential wall in the region of the combustion air inlet opening. The combustion air inlet openings may be arranged in a plurality of rows. In this case, the combustion air inlet openings of different rows can have different inclination angles of the opening longitudinal axes. In particular, the combustion air inlet opening is inclined to such an extent that no residual radial opening is present with respect to a view in the direction of the surface normal. At a high inclination angle greater than 40°, the penetration depth in particular is insufficient.

Another heating device for a burner operated with liquid fuel is known from DE 30 10 078 A1. The heating device has a low-pressure atomizer. The heating device has oblique swirl openings in a circumferential wall. With typical wall thicknesses in the range of 1.0 to 2.0 mm, the wall thickness of a circumferential wall is still too small to ensure swirl support in all operating conditions. Furthermore, production engineering conditions, e.g. during master molding, result in broken edges or chamfers at the openings, especially swirl openings, and thus an air supply opening channel of a swirl opening is effectively shorter and thus less efficient. Thickening of the circumferential wall in turn reduces the thermal economy of a burner.

It is an object of the disclosure to disclose an improved burner for a mobile fuel-operated heating device and a mobile fuel-operated heating device, as well as a method for producing a burner.

The object of the disclosure is solved with respect to the burner by the features of claim 1, with respect to the heating device by the features of claim 14, with respect to the method by the features of claim 15. Suitable embodiments result from the respective dependent claims.

The burner according to the disclosure for a mobile fuel-operated heating device, in particular for a vehicle heating device, comprises:

an evaporator receiving body for receiving an evaporator assembly for distributing and evaporating liquid fuel, and at least one fuel supply line for supplying liquid fuel to the evaporator assembly. Advantageously, the evaporator assembly includes an evaporator. For example, an evaporator may be formed of a metal grid or a porous material having a large surface area. For the purposes of the present disclosure, a burner is understood to be a component assembly, in particular a component to which fuel and combustion air are supplied for conversion into heat, in particular for a combustion process. The burner has a combustion chamber. The burner has a circumferential wall with a plurality of air supply openings. Preferably, the circumferential wall partially bounds the combustion chamber.

The circumferential wall has an increased thickness at least in a first region surrounding one of the air supply openings compared to a second region located between two air supply openings. An air supply opening has an inlet opening on an outer side of the circumferential wall and an outlet opening on an inner side of the circumferential wall. An air supply opening passage of the air supply opening is formed between the inlet opening and the outlet opening. The thickening in the first region extends the air supply opening channel of the air supply opening. By “thickening” is meant the change or a difference from the thickness in the second region, i.e., the thickness of the circumferential wall itself, to a first region. Purposeful thickening in the region of an air supply opening has the advantage that the wall thickness of the circumferential wall can generally be kept low and, at the same time, a guide length of an air supply opening channel can be increased. In the case of an air supply opening channel which is arranged perpendicular to the circumferential wall, an increased penetration depth of the air jet can be achieved by the increased guide length, and in the case of an inclined or sloping air supply opening channel, a twisting or swirling of the air can be increased by the increased guide length. Such a burner is particularly suitable for use in continuous combustion mode or with very strong partial load reduction. A burner characteristic diagram can be extended and fuel mixtures can be used.

In one embodiment, the air supply openings are arranged along at least two, in particular two to four, rows in the circumferential direction of the circumferential wall.

In a further embodiment, the circumferential wall has at least one projection which comprises an opening surface of the air supply opening, the projection being arranged on an inner side of the circumferential wall or on an outer side of the circumferential wall. When a protrusion is provided on an inner side of the circumferential wall, it is particularly possible that a swirled air guide does not extend directly along the wall, but is formed in a detached manner at a desired distance from the circumferential wall. It is also possible that a first region is formed by two projections opposing each other on both sides of the circumferential wall. Expediently, a base surface of the opposing projections is thereby congruent. If necessary, at least one projection can also be arranged on an inner side of the circumferential wall and one projection on an outer side of the circumferential wall, in particular in the region of the same air supply opening (or if necessary also in the region of different air supply openings).

Expediently, the projection is at least partially beveled in an outer region. A bevel, in particular a bevel around the entire projection, improves air flow in the area of the projection.

In one embodiment, air supply openings comprise first air supply openings with a first opening longitudinal axis, a first inlet surface, and a first outlet surface and second air supply openings with a second opening longitudinal axis, a second inlet surface, and a second outlet surface. In this case, the first opening longitudinal axis forms a first angle relative to a circumferential wall normal of the first air supply opening. The second opening longitudinal axis forms a second angle (deviating from the first angle, in particular deviating in magnitude from the first angle) relative to a circumferential wall normal of the second air supply opening.

Expediently, the first angle and/or the second angle is/are selected such that the first inlet surface and the first outlet surface and the second inlet surface and the second outlet surface, respectively, at least partially overlap in the projection direction of the circumferential wall normal. This embodiment provides a residual opening in a circumferential normal direction.

In a further embodiment, the first angle and the second angle are at most 40° and/or exclusively the first angle is 0°.

The first angle and/or the second angle may lie in a plane spanned by the circumferential wall normal and a circumferential direction (at the location of the respective air supply opening). Alternatively or additionally, the first angle and/or the second angle can lie in a (respective) plane spanned by the respective row.

In an alternative embodiment, the first angle and/or the second angle may lie in a plane spanned by the circumferential wall normal (at the location of the respective air supply opening) and a central axis of the circumferential wall. In particular, the first angle and/or the second angle may lie in a plane spanned by the circumferential normal (at the location of the respective air supply opening) and a perpendicular to a plane spanned by the respective row.

Alternatively, the first angle and/or the second angle may be oblique to a plane (respectively the above) spanned by the circumferential wall normal and a circumferential direction at the location of the respective air supply opening. Alternatively or additionally, the first angle and/or the second angle may be oblique to a plane spanned by the respective row (of air supply openings).

In an embodiment, the air supply openings further comprise third air supply openings or third and fourth air supply openings having a third angle and optionally fourth angle different from the first angle and the second angle. The air supply openings may include a plurality of air supply openings each having a different angle. Even though in principle each air supply opening may have an angle different from all other air supply openings, the precise design of the burner, e.g. by means of flow simulation, is costly.

In an expedient embodiment, air supply openings adjacent at least in the circumferential direction, in particular air supply openings adjacent in all directions, are air supply openings with different angles. This is achieved, for example, by an arrangement in which first and second air supply openings alternate. The next row can then start with an offset.

In particular, the air supply openings may be arranged along the circumferential direction in a periodic pattern, where in particular all rows of air supply openings have the same pattern. For example, such a pattern may be A-B-A-B; A-B-C-A-B-C, A-AB-B-A-A-B-B, A-A-B-A-A-B, A-B-C-B-A-B-C.

Further, the air supply openings may be arranged axis-symmetrically with respect to the central axis of the circumferential wall.

Expediently, the air supply openings are equally spaced along the circumferential direction. In this case, only the air supply openings of a respective row can be at the same distance from one another or all rows can be at the same distance from one another.

In a further embodiment, the circumferential wall has an increased thickness exclusively in the first region of first air supply openings or exclusively in the first region of second air supply openings. In an expedient embodiment, the circumferential wall has a first thickening in the first region of first air supply openings and a second thickening in the first region of second air supply openings, wherein the first thickening and the second thickening have different thicknesses.

The air supply openings may be equally spaced along the circumferential direction.

Expediently, the thickness of the wall in a second region is 0.5 to 3.0 mm, preferably 1.0 to 2.0 mm, and/or the thickness of the wall in a first region is increased by 0.2 to 3.0 mm (relative to the second region).

In one embodiment, the circumferential wall periodically has first regions of increased thickness in the circumferential direction.

In one embodiment, the circumferential wall is arranged at an evaporator receiving body. Such an evaporator receiving body expediently has a bottom region. Advantageously, the circumferential wall extends from the bottom region. The fuel supply line may open into the bottom region of the evaporator receiving body.

The mobile heating device according to the disclosure, in particular mobile vehicle heating device, comprises a burner according to the disclosure. Such a heating device is particularly suitable for use in land vehicles.

The method according to the disclosure for producing a burner, in particular a burner according to the disclosure, comprises:

Selecting a first thickness of the circumferential wall,

Selecting at least one increase in thickness for the first regions as a function of an angle of the air supply openings to a normal of the circumferential wall,

forming first regions in particular by applying protrusions to the circumferential wall.

Alternatively, a circumferential wall with a second thickness can be provided and then the material thickness can be removed in the second regions.

The disclosure is also explained in more detail below with respect to further features and advantages by means of the description of embodiment examples and with reference to the accompanying drawings. It shows in each case in a principle drawing:

FIG. 1 evaporator receiving arrangement according to the prior art;

FIG. 2 evaporator receiving body with partially inclined air supply openings (not according to the present disclosure);

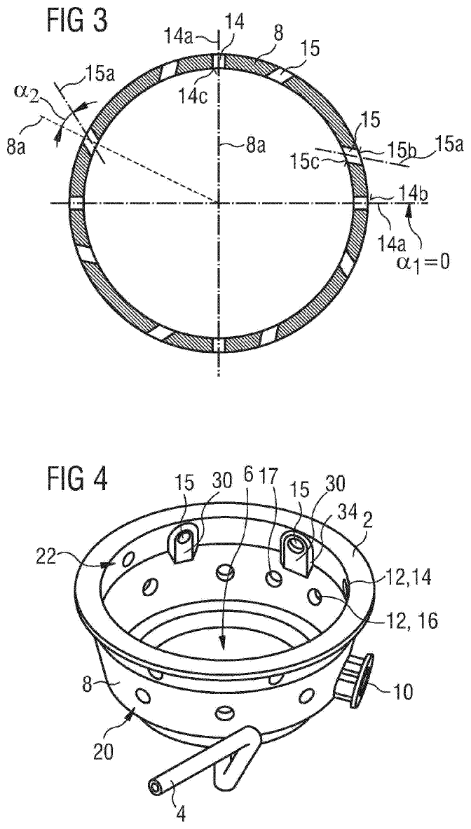

FIG. 3 cut along a row of air supply openings of the evaporator receiving body according to FIG. 2;

FIG. 4 first embodiment of an evaporator receiving body;

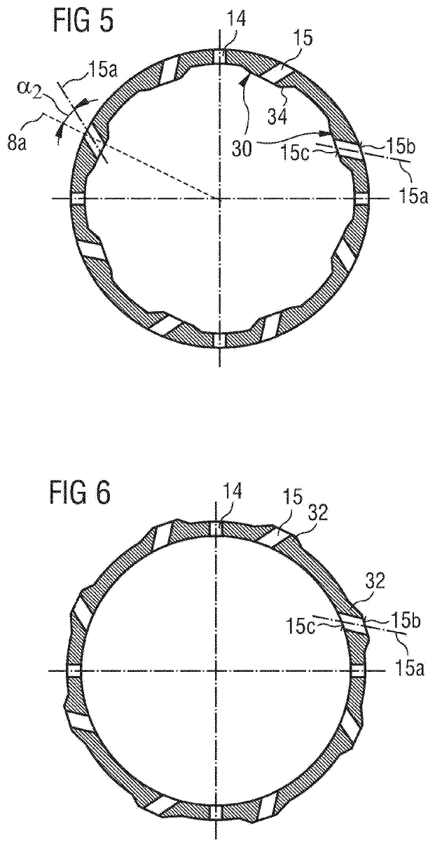

FIG. 5 cut along a row of air supply openings of a second embodiment; and

FIG. 6 cut along a row of air supply openings of a third embodiment.

FIG. 2 shows an evaporator receiving body 2 (not according to this disclosure). The evaporator receiving body 2 has a bottom region 6. The fuel supply line 4 opens into the bottom region. The fuel supply line 4 can, for example, be designed as a tube. In the illustrated representation, the bottom region 6 has a recess which is suitable for receiving an evaporator assembly.

A circumferential wall 8 extends from the bottom region 6. The circumferential wall is cylindrical in sections and conical in sections. An exclusively cylindrical design is also possible as an alternative. In a lower section of the circumferential wall, i.e. close to the bottom region 6, a receiving element 10 is arranged, which is suitable for receiving an ignition element and/or a flame guard. The height of the receiving element 10, measured from the bottom region, is in particular adapted to the size of the evaporator assembly.

A plurality of air supply openings 12 are provided in the circumferential wall 8. In the example shown, the air supply openings 12 are arranged in two rows 20, 22 in the circumferential direction. However, arrangement in only one row or in multiple rows is also possible. In FIG. 2, the number of air supply openings 12 in the row 20 is greater than in the row 22. In the row 20, moreover, the distance between the air supply openings 12 varies.

Here, first and second air supply openings 14, 15 are arranged in the row 22, and third and fourth air supply openings 16, 17 are arranged in the row 20.

The first air supply opening 14 is designed here with a first angle α1 of 0°. In this case, the circumferential wall normal 8a, i.e. the perpendicular of the circumferential wall 8, in the area of the first air supply opening 14 and a first opening longitudinal axis 14a are parallel to each other. With a cylindrical air supply opening 14, the first inlet surface 14b and the first outlet surface 14c completely overlap in projection along the circumferential wall normal 8a, see also FIG. 3.

Here, the second air supply opening 15 is formed at an angle. The second opening longitudinal axis 15a of the second air supply opening 15 and the circumferential wall normal 8a in the region of the second air supply opening 15 are at a second angle α2 to each other. In this case, this second angle α2 lies exclusively in a plane spanned by the circumferential wall normal 8a and the circumferential direction. When the second air supply opening 15 is cylindrical, the second inlet surface 15b and the second outlet surface 15c partially overlap in projection along the circumferential wall normal 8a.

Here, the third air supply opening 16 is formed with a third angle α3 of 0°. In this case, the circumferential wall normal 8a, i.e., the perpendicular of the circumferential wall 8, in the region of the third air supply opening 16 and a third opening longitudinal axis 16a are parallel to each other. With the air supply opening being cylindrical, the third inlet surface 16b and the third outlet surface 16c completely overlap in projection along the circumferential wall nor-mal 8a.

The fourth air supply opening 17 is formed obliquely here. The fourth opening longitudinal axis 17a of the fourth air supply opening 17b and the circumferential wall normal 8a in the region of the second air supply opening are at a fourth angle α4 to each other. In this case, this fourth angle α4 lies exclusively in a plane spanned by the circumferential wall normal 8a and the central axis. With the fourth air supply opening 17 being cylindrical, the fourth inlet surface 17b and the fourth outlet surface 17c partially overlap in projection along the circumferential wall normal 8a.

FIG. 3 shows an exemplary cut through a row of air supply openings of the evaporator receiving body according to FIG. 2 (not according to the present disclosure). In the section shown, first air supply openings 14 and second air supply openings 15 are arranged periodically. The periodicity here is A-B-B-A-B-B . . . . The angles α1 and α2 are intended to be exclusively in the plane shown in this figure. Here, the first air supply opening 14 is perpendicular to the circumferential wall 8. Thus, circumferential wall normal 8a and first opening longitudinal axis 14a are superimposed. The first outlet surface 14c of the first air supply opening 14 is arranged on the inner side of the circumferential wall 8, and the first inlet surface 14b is arranged on the outer side of the circumferential wall 8. The first inlet surface 14b and the first outlet surface 14c completely overlap in projection along the circumferential wall normal 8a.

The second air supply opening 15 runs obliquely. Thus, circumferential wall normal 8a and second opening longitudinal axis 15a are at a second angle α2 to each other. On the inner side of the circumferential wall 8, the second outlet surface 15c of the second air supply opening 15 is arranged, and on the outer side of the circumferential wall 8, the second inlet surface 15b is arranged. The second inlet surface 15b and the second outlet surface 15c partially overlap in projection along the circumferential wall normal 8a. Thus, an opening is provided when viewed along the circumferential wall normal 8a. The circumferential wall has a uniform thickness t.

FIG. 4 shows an embodiment of a burner with an evaporator receiving body 2. The evaporator receiving body 2 has a bottom region 6. A fuel supply line 4 opens into the bottom region. The fuel supply line can, for example, be designed as a tube. In the embodiment shown, the bottom region 6 has a recess which is suitable for receiving an evaporator assembly.

A circumferential wall 8 extends from the bottom region 6. The circumferential wall is cylindrical in sections and conical in sections. Alternatively, an exclusively cylindrical design is also possible. In a lower section of the circumferential wall 8, i.e. near the bottom region 6, a receiving element 10 is arranged which is suitable for receiving an ignition element and/or a flame monitor. The height of the receiving element 10, measured from the bottom region, is in particular adapted to the size of the evaporator assembly.

A plurality of air supply openings 12 is provided in the circumferential wall 8. In the example shown, the air supply openings 12 are arranged in two rows 20, 22 in the circumferential direction. However, an arrangement in only one row or in several rows is also possible. In FIG. 4, the number of air supply openings in row 20 is greater than in row 22. Furthermore, in row 20, the distance between air supply openings 20 varies.

In row 22, first and second air supply openings 14, 15 are arranged here, and third and fourth air supply openings 16, 17 are arranged in row 20. However, in alternative embodiments, it could also be exclusively first air supply openings 14 or exclusively first and second air supply openings 14, 15.

The first air supply opening 14 is designed here with a first angle α1 of 0°. In this case, the circumferential wall normal 8a, i.e. the perpendicular of the circumferential wall, in the area of the air supply opening and a first opening longitudinal axis 14a are parallel to each other. When the air supply opening is cylindrical, the first inlet surface 14b and the first outlet surface 14c completely overlap in projection along the circumferential wall normal 8a.

Here, the second air supply opening 15 is formed obliquely. The second opening longitudinal axis 15a of the second air supply opening 15 and the circumferential wall normal 8a in the region of the second air supply opening are at a second angle α2 to one another. In this case, this second angle α2 lies exclusively in a plane spanned by the circumferential wall normal 8a and the circumferential direction. When the second air supply opening is cylindrical, the second inlet surface and the second outlet surface partially overlap in projection along the circumferential wall normal. In the region of each of the second air supply openings 15, projections 30 are formed on an inner surface of the circumferential wall. The projections 30 have a gate shape in the viewing direction, that is, the projections extend toward the lower tapered portion of the circumferential wall. A partially circumferential side wall 34 of each projection 30 is beveled.

Here, the third air supply opening 16 is designed with a third angle α3 of 0°. In this case, the circumferential wall normal, i.e. the perpendicular of the circumferential wall, in the region of the air supply opening and a third opening longitudinal axis are parallel to each other. When the air supply opening is cylindrical, the third inlet surface 16b and the third outlet surface 16c completely overlap in projection along the circumferential wall normal.

Here, the fourth air supply opening 17 is formed obliquely. The fourth opening longitudinal axis 17a of the fourth air supply opening 17b and the circumferential wall normal 8a in the region of the fourth air supply opening are at a fourth angle α4 to each other. In this case, this fourth angle α4 lies exclusively in a plane spanned by the circumferential wall normal and the central axis. When the fourth air supply opening is cylindrical, the fourth inlet surface 17b and the fourth outlet surface 17c partially overlap in projection along the circumferential wall normal 8a.

FIG. 5 shows an exemplary section through the row 22 of air supply openings of the evaporator receiving body according to FIG. 4. In the section shown, first air supply openings 14 and second air supply openings 15 are arranged periodically. The periodicity here is A-B-B-A-B-B . . . . The angles α1 and α2 are to be exclusively in the plane shown. Here, the first air supply opening 14 is perpendicular to the circumferential wall 8. Thus, circumferential wall normal 8a and first opening longitudinal axis 14a are superimposed. The first outlet surface 14c of the first air supply opening 14 is arranged on the inner side of the circumferential wall, and the first inlet surface 14b is arranged on the outer side of the circumferential wall 8. The first inlet surface 14b and the first outlet surface 14c completely overlap in projection along the circumferential wall normal 8a. The first outlet surface 14c of the first air supply opening 14 is arranged on the inner side of the circumferential wall 8, and the first inlet surface 14b is arranged on the outer side of the circumferential wall 8. The first inlet circumferential 14b and the first outlet surface 14c completely overlap in projection along the circumferential wall normal 8a. In the region of the first air inlet opening 14, the circumferential wall has the circumferential wall thickness. There is no thickening. An air supply opening channel of the first air supply opening 14 is thus relatively short.

The second air inlet opening 15 extends obliquely. Thus, circumferential wall normal 8a and second opening longitudinal axis 15a lie one above the other at a second angle α2 to each other. The second outlet surface 15c of the second air supply opening 15 is arranged on the inner side of the circumferential wall 8, and the second inlet surface 15b is arranged on the outer side of the circumferential wall 8. The second inlet surface 15b and the second outlet surface 15c partially overlap in projection along the circumferential wall normal 8a. Thus, an opening is provided as viewed along the circumferential wall normal 8a. First projections 30 are arranged around the second air supply openings on the inside of the circumferential wall. In the example shown, the first projections 30 have an equal thickness at the respective outlet surface of the second air supply opening 15. On a side facing away from the outlet surface of the second air supply opening 15, the projection 30 has beveled side walls 34. A thickening is present. An air supply opening passage of the second air supply opening 15 is thus relatively long, thus improving the swirl of the combustion air.

FIG. 6 shows an exemplary cut through a row of air supply openings of an alternative embodiment of an evaporator receiving body. Deviating from the cut shown in FIG. 5, second projections 32 are arranged on the outer side of the circumferential wall instead of the first projections 30 on the inner side. The second projections are also arranged here in the region of the second air supply openings 15. In this embodiment, the circumferential wall is smooth or without protrusions on an inner side apart from the outlet surfaces.

Even though the disclosure is illustrated using the example of a burner with an evaporator receiving body, a circumferential wall with the air supply openings described above can also be arranged elsewhere in the burner, for example with a housing, as a separate component.

### REFERENCE NUMERALS

2 evaporator receiving body
4 fuel supply line
6 bottom region
8 circumferential wall
8a circumferential wall normal
10 receiving element
12 air supply opening
14 first air supply opening
14a first opening longitudinal axis
14b first inlet surface
14c first outlet surface
15 second air supply opening
15a second opening longitudinal axis
15b second inlet surface
15c second outlet surface
16 third air supply opening
16a third opening longitudinal axis
16b third inlet surface
16c third outlet surface
17 fourth air supply opening
17a fourth opening longitudinal axis
17b fourth inlet surface
17c fourth outlet surface
20 row
22 row
30 first projection
32 second projection
34 beveled side wall
α1 first angle
α2 second angle
α3 third angle
α4 fourth angle
t thickness

1. A burner for a mobile fuel-operated vehicle heating device, comprising
an evaporator receiving body for receiving an evaporator assembly for distributing and evaporating liquid fuel, and
at least one fuel supply line for supplying liquid fuel to the evaporator assembly, wherein the burner has a circumferential wall with a plurality of air supply openings, and wherein the circumferential wall has an increased thickness at least in a first region surrounding one of the air supply openings compared to a second region located between two air supply openings.

2. The burner according to claim 1, wherein the air supply openings are arranged along at least two rows in the circumferential direction of the circumferential wall.

3. The burner according to claim 1, wherein the circumferential wall has at least one projection which comprises an opening surface of the air supply opening, wherein the projection is arranged on an inner side of the circumferential wall and/or on an outer side of the circumferential wall.

4. The burner according to claim 1, wherein the projection is at least partially beveled in an outer region.

5. The burner according to claim 1, wherein the air supply openings comprise first air supply openings having a first opening longitudinal axis, a first inlet surface and a first outlet surface, and second air supply openings each having a second opening longitudinal axis, a second inlet surface and a second outlet surface,
wherein the first opening longitudinal axis forms a first angle α1 to a circumferential wall normal to the first air supply opening,
wherein the second opening longitudinal axis forms a second angle α2, different from the first angle, to a circumferential wall normal to the second air supply opening, and
wherein the first angle α1 and the second angle α2 are selected such that the first inlet surface and the first outlet surface as well as the second inlet surface and the second outlet surface at least partially overlap in the projection direction of the circumferential wall normal.

6. The burner according to claim 1, wherein the first angle α1 and the second angle α2 are at most 40°, and/or wherein exclusively the first angle α1 is 0°.

7. The burner according to claim 1,
wherein the first angle α1 and/or the second angle α2 lies/lie in a plane spanned by the circumferential wall normal and a circumferential direction at the location of the respective air supply opening, and/or wherein the first angle α1 and/or the second angle α2 lies/lie in a plane spanned by the respective row, or
wherein the first angle α1 and/or the second angle α2 lies/lie in a plane spanned by the circumferential wall normal at the location of the respective air supply opening and a central axis of the circumferential wall, or
wherein the first angle α1 and/or the second angle α2 is/are oblique to a plane spanned by the circumferential wall normal and a circumferential direction at the location of the respective air supply opening, and/or wherein the first angle α1 and/or the second angle α2 is/are oblique to a plane spanned by the respective row.

8. The burner according to claim 1, wherein the air supply openings further comprise third air supply openings or third and fourth air supply openings having a third angle α3 and optionally fourth different angle α4 different from the first angle and the second angle, or wherein the air supply openings comprise a plurality of air supply openings each having different angles.

9. The burner according to claim 1, wherein the circumferential wall has an increased thickness exclusively in the region of first air supply openings or exclusively in the region of second air supply openings.

10. The burner according to claim 1, wherein the air supply openings are equally spaced along the circumferential direction.

11. The burner according to claim 1, wherein the thickness of the circumferential wall in at least a second region is 0.5 to 3.0 mm, preferably 1.0 to 2.0 mm, and the thickness of the circumferential wall in at least a first region is increased by 0.2 to 3.0 mm.

12. The burner according to claim 1, wherein the circumferential wall periodically has first regions with an increased thickness in the circumferential direction.

13. The burner according to claim 1, wherein the circumferential wall is arranged on an evaporator receiving body having a bottom region.

14. A mobile vehicle heating device, comprising a burner according to claim 1.

15. A method of producing a burner according to claim 1 comprising,
selecting a first thickness of the circumferential wall,
selecting at least one increase in thickness for the first regions depending on an angle of the air supply openings to a normal to the circumferential wall, and
forming first regions in particular by applying protrusions to the circumferential wall.

16. The burner according to claim 1, wherein the air supply openings are arranged along two to four rows in the circumferential direction of the circumferential wall.
